(19) United States
(12) Patent Application Publication
(10) Pub. No.: US 2022/0336827 A1
(43) Pub. Date: Oct. 20, 2022

(54) FUEL CELL AND CORRESPONDING MANUFACTURING METHOD

(71) Applicant: SYMBIO, FONTAINE (FR)

(72) Inventors: Christophe BAVEREL, Audincourt (FR); Sébastien ROYER, Dasle (FR); Yannick GODARD, Blussans (FR); Frédéric GREBER, Ecot (FR)

(21) Appl. No.: 17/633,091

(22) PCT Filed: Aug. 3, 2020
(86) PCT No.: PCT/FR2020/051424

§ 371 Date: Feb. 4, 2022

(30) Foreign Application Priority Data
Aug. 5, 2019 (FR) 1908959

(51) Int. Cl. H01M 8/0273; H01M 8/1004; H01M 8/0284; H01M 8/0247; H01M 8/0258; H01M 8/242; H01M 8/0286

(52) U.S. Cl. CPC H01M 8/0273; H01M 8/1004; H01M 8/0284; H01M 8/0247; H01M 8/0258; H01M 8/242; H01M 8/0286

(57) ABSTRACT

The fuel cell comprises for each MEA: an anodic volume for the circulation of an anodic fluid between the anode of the MEA and a bipolar plate and a cathodic volume for the circulation of a cathodic fluid between the anode of the MEA and another bipolar plate, one of the anodic volume and the cathodic volume is sealed by a cordon of a sealing material extending along a peripheral outer edge of the MEA, wherein the sealing material is in direct contact with the MEA and the corresponding bipolar plate; wherein the other of the anodic volume and the cathodic volume is sealed off from the fluid circulating in the volume by a direct contact line of the MEA with the corresponding bipolar plate, the contact line extending along a peripheral outer edge of the MEA.

In general, this invention concerns the sealing of fuel cells.

A fuel cell typically comprises:
a plurality of membrane-electrode assemblies (MEAs), each comprising an anode and a cathode;
a plurality of bipolar plates.

The MEAs and the bipolar plates are stacked such that each MEA is arranged between two bipolar plates, with an anodic volume for the circulation of an anodic fluid being delimited between the anode and one of the two bipolar plates, and a cathodic volume for the circulation of an cathodic fluid being delimited between the anode and the other of the two bipolar plates.

It is necessary to create a seal around the anodic volume and around the cathodic volume in order to avoid fluid loss.

It is possible to create a seal on both sides of the MEA. These seals are created by depositing a cordon of a sealing material on the MEA or the bipolar plates.

Such a solution does not allow for the reliable creation of joints with a thickness of less than 0.25 mm.

Moreover, fuel cells must be very compact, particularly those intended for placement on board motor vehicles. In certain cases, the cumulative clearance for the two seals on either side of each MEA is generally between 0.3 and 0.5 mm.

Thus, there is a need for a fuel cell that is compact in height and has a good seal around the anodic and cathodic volumes.

To this end, in a first aspect, the invention concerns a fuel cell comprising:
a plurality of MEAs, each comprising an anode and a cathode;
a plurality of bipolar plates;

wherein the MEAs and the bipolar plates are stacked such that each MEA is arranged between two bipolar plates, wherein an anodic volume for the circulation of an anodic fluid is delimited between the anode and one of the two bipolar plates, and a cathodic volume for the circulation of an cathodic fluid is delimited between the anode and the other of the two bipolar plates;

wherein one of the anodic volume and the cathodic volume is sealed by a cordon of a sealing material, wherein the sealing material is in direct contact with the MEA and the corresponding bipolar plate;

wherein the other of the anodic volume and the cathodic volume is sealed off from the fluid circulating in the volume by a direct contact line of the MEA with the corresponding bipolar plate.

Because the anodic or cathodic volume is sealed off to the fluid circulating in the volume by a direct contact line between the MEA and the corresponding bipolar plate, it is possible to create a cordon of sealing material that is thick enough to enclose the other volume.

The thickness of the joint is sufficient to compensate any unevenness of the bipolar plates. When they are compressed within the fuel cell, the seal between a bipolar plate and the joint is ensured by the deformation of the joint, which compensates for the unevenness of the bipolar plates in relation to the joint. The seal between a bipolar plate and the MEA (in direct contact with the metal) is ensured by the deformation of the plastic reinforcement of the MEA, which compensates for the surface defects of the rib of the plate that faces the MEA.

This cordon may be formed using known-art deposition techniques.

In the case of the above example, the cumulative clearance for the seals on either side of each MEA is 0.3 mm. The seal on one side of the MEA, at the level of the direct contact line, has a thickness equal to nil. The thickness of the cordon of sealing material may thus be up to 0.3 mm. This cordon may be obtained, e.g., by injection moulding.

Additionally, the fuel cell includes one less component, i.e. the seal that is replaced by the direct contact line.

The fuel cell may also have one or more of the following features, taken individually or in any combination technically possible:
the sealing material is a silicone, an EPDM, or a thermoplastic, e.g. a polypropylene-EPDM composite material;
the cordon of sealing material has a thickness of between 0.25 and 0.75 mm;
the MEA has an outer circumferential frame of plastic material surrounding the active zone, wherein the corresponding bipolar plate is in direct contact with the outer circumferential frame;
the MEA is in direct contact with a metal zone of the bipolar plate;
the MEA is in direct contact with a textured zone of the bipolar plate;
each bipolar plate has an outer edge, with the portion of the cordon of sealing material following the outer edge;
each bipolar plate has an outer edge, with the portion of the contact line following the outer edge;
each bipolar plate includes an inlet for anodic fluid, an inlet for cathodic fluid, an outlet for anodic fluid, and an outlet for cathodic fluid, wherein the cordon of sealing material and/or the direct contact line extend around one or more of the inlets/outlets.

In a second aspect, the invention concerns a method for producing a fuel cell, comprising the following steps:
obtaining a plurality of MEAs, each comprising an anode and a cathode;
obtaining a plurality of bipolar plates;
stacking the MEAs and the bipolar plates such that each MEA is arranged between two bipolar plates, wherein an anodic volume for the circulation of an anodic fluid is delimited between the anode and one of the two bipolar plates, and a cathodic volume for the circulation of an cathodic fluid is delimited between the anode and the other of the two bipolar plates;
for each MEA: depositing a cordon of a sealing material on one of the anodic volume and the cathodic volume between the MEA and the corresponding bipolar plate;
compressing the stack, wherein the one of the anodic volume and the cathodic volume is sealed by the sealing material, which comes into direct contact with the MEA and the corresponding bipolar plate;

wherein the other of the anodic volume and the cathodic volume is sealed off from the fluid circulating in the volume by the MEA being placed in direct with the corresponding bipolar plate along a direct contact line.

Other characteristics and advantages of the invention will be seen from the following detailed description, provided by way of example only, which refers to the attached drawings, which show:

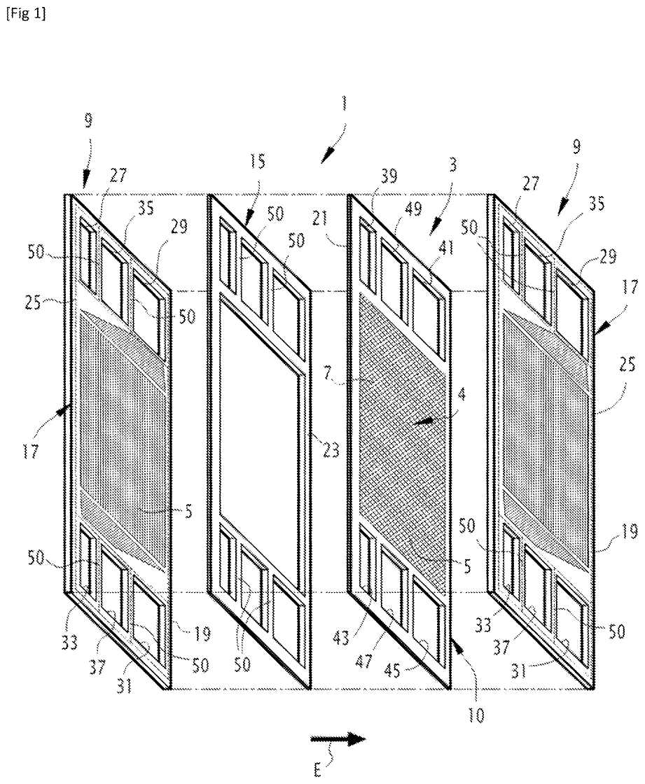

FIG. 1 is a simplified, exploded schematic representation of part of a fuel cell according to the invention;

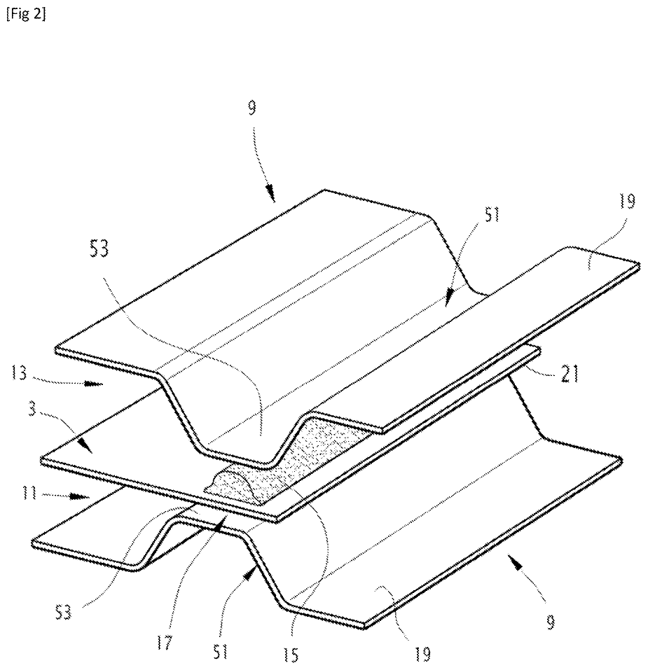

FIG. 2 is an enlarged perspective view of a detail of the fuel cell of FIG. 1, showing the seal provided by a cordon of sealing material between the MEA and one of the bipolar plates, and the contact line between the MEA and the other bipolar plate; and

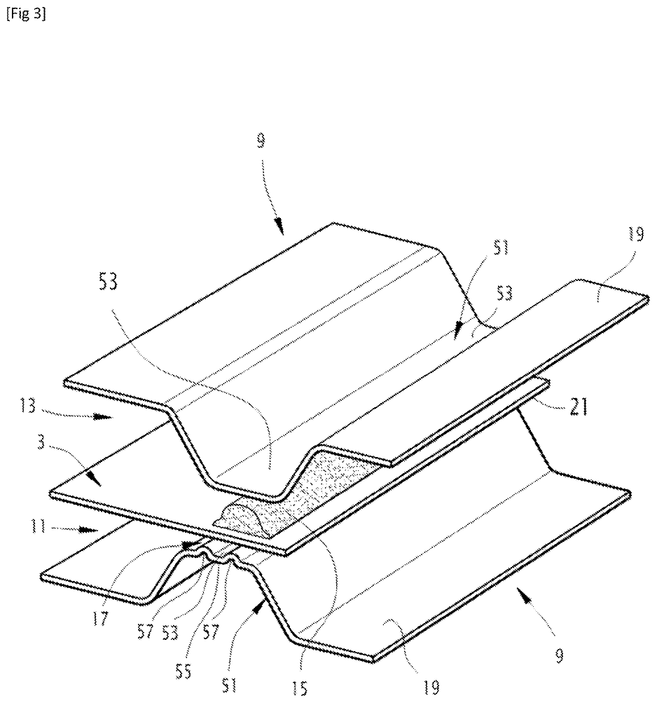

FIG. 3 is a view similar to that of FIG. 2 for one embodiment of the invention. The fuel cell 1 shown in part in FIG. 1 comprises a plurality of MEAs 3, each having an active zone 4 with an anode 5 and a cathode 7, and a plurality of bipolar plates 9.

Each MEA 3 also comprises a membrane (not shown) between the anode 5 and the cathode 7. The anode 5 and the cathode 7 thus constitute the two opposite outer surfaces of the MEA 3.

The MEA 3 also has an outer circumferential frame 10 of plastic material surrounding the active zone 4.

Typically, the fuel cell is a proton exchange membrane or polymer electrolyte membrane fuel cell.

The MEAs 3 and the bipolar plates 9 are stacked such that each MEA 3 is arranged between two bipolar plates 9.

An anodic volume 11 for the circulation of an anodic fluid is delimited between the anode 5 and one of the two bipolar plates 9, and a cathodic volume 13 for the circulation of a cathodic fluid is delimited between the anode 7 and the other of the two bipolar plates 9.

The anodic fluid is typically dihydrogen.

The cathodic fluid typically comprises dioxygen. For example, the cathodic fluid is air.

Each bipolar plate 9 is placed between two MEAs 3, and delimits the anodic volume 11 of one of the two MEAs and the cathodic volume 113 of the other MEA 3. Typically, it has flow channels for the anodic fluid (not shown) on a surface delimiting the anodic volume 11, and flow channels for the cathodic fluid (not shown) on a surface delimiting the cathodic volume 13.

For example, each bipolar plate 9 consists of two electrically conductive sheets assembled together. They are made of stainless steel, a titanium, aluminium, nickel, or tantalum alloy, or any other suitable material.

Advantageously, channels for the circulation of a coolant are placed between the two sheets (not shown).

The operation of the proton exchanger fuel cell 1 will be briefly discussed below.

The anodic fluid flows within the anodic volume 11, and the cathodic fluid flows within the cathodic volume 13.

At the anode 5, the dihydrogen is ionised in order to produce protons that cross the MEA 3. The electrons produced by this reaction are collected by the bipolar plate 9 on the side of the anode 5. The electrons produced are then applied to an electrical load connected to the fuel cell 1 to form an electrical current.

At the cathode, oxygen is reduced, and reacts with protons to form water. The reactions at the anode and cathode are as follows:

Anode:H₂→2H⁺+2e⁻

Cathode:4H⁺+4e⁻+O₂→2H₂O

During its operation, a cell of the fuel cell usually generates a continuous voltage between the anode and the cathode on the order of 1 V. A cell corresponds to an MEA 3 stacked between two bipolar plates 9.

One of the anodic volume 11 and the cathodic volume 13 is sealed by a cordon 15 of a sealing material.

In other words, the fluid circulating within the anodic volume 11 or the cathodic volume 13 is sealed in by the cordon 15.

The sealing material is in direct contact with the MEA 3 and the corresponding bipolar plate 9.

The cordon 15 typically consists only of the sealing material, with no other components.

Advantageously, the sealing material is a silicone, an EPDM, or a thermoplastic, e.g. a polypropylene-EPDM composite material.

The cordon 15 of sealing material has a thickness of between 0.25 and 0.75 mm, preferably between 0.4 and 0.5 mm. This thickness is measured in the direction of stacking of the MEAs and the bipolar plates in the fuel cell, indicated by the arrow E in FIG. 1.

The other of the anodic volume 11 and the cathodic volume 13 is sealed off from the fluid circulating in the volume by a direct contact line 17 of the MEA 3 and the corresponding bipolar plate 9.

In other words, the fluid circulating within this volume is sealed within the volume by direct contact between the material forming the MEA 3 and the material forming the bipolar plate 9 along the line 17. This contact is sufficiently close to seal in the fluid.

In the example shown, the anodic volume 11 is enclosed by the direct contact line 15, and the cathodic volume 13 is enclosed by the cordon 15 of sealing material.

In one variant, the cathodic volume 13 is enclosed by the direct contact line 15, and the anodic volume 11 is enclosed by the cordon 15 of sealing material.

The MEA 3 is advantageously in direct contact with the corresponding bipolar plate 9 along the line 17 via the outer circumferential frame 10, which is made of a plastic material.

For example, this plastic material is PET (polyethylene terephthalate), PEN (polyethylene naphthalate), or Kapton®.

The MEA 3 is in direct contact with a metal or graphite zone of the bipolar plate 9.

The plastic material is relatively deformable when pressed against the metal, such that a high degree of sealing can be provided when the stack of bipolar plates 9 and MEAs 3 is placed under pressure in the stacking direction E.

The outer circumferential frame 10 completely surrounds the active zone 4. It is applied to the membrane of the MEA 3, e.g. overmoulded around the membrane.

Typically, the cordon 15 of sealing material and the contact line 17 are exactly superimposed. They have the same outline and are placed in the same position relative to the MEA 3.

Each bipolar plate 9 has an outer edge 19.

The outer edge 19 extends over the entire circumference of the bipolar plate 9.

Each MEA 3 has an outer circumferential edge 21.

The outer circumferential edge 21 extends over the entire circumference of the MEA 3.

The MEAs 3 and the bipolar plates 9 have substantially the same general shape.

Typically, the peripheral edges 19 of two bipolar plates 9 surrounding the same MEA 3 extend slightly outward beyond the outer circumferential edge 21 of the MEA (FIG. 2). The edge 21 is offset relative to the edges 19 of the two bipolar plates.

The cordon 15 of sealing material comprises a portion 23 following the outer circumferential edge 21 of the MEA 3.

The portion 23 follows the edge 21 over its entire circumference.

It is in close proximity with the outer circumferential edge 21.

This means that it is at a distance of less than 5 cm, preferably 3 cm, more preferably 1 cm.

Likewise, the contact line 17 comprises a portion 25 that follows the outer circumferential edge 21 of the MEA 3.

The portion 25 follows the edge 21 over its entire circumference.

It is in close proximity with the outer circumferential edge 21.

This means that it is at a distance of less than 5 cm, preferably 3 cm, more preferably 1 cm.

The portions 23 and 25 seal off the volumes 11 and 13 to the outside of the fuel cell 1 at the outer circumference of the volumes 11 and 13.

The portions 23 and 25 each have a closed contour.

Likewise, the portion 23 of the cordon 15 of sealing material follows the outer edge 19 of each of the two bipolar plates 9 framing the MEA 3.

The portion 25 of the contact line 17 follows the outer edge 19 of the other bipolar plate 9 framing the MEA 3.

The portions 23 and 25 follow the edges 19 over their entire respective circumferences.

They are each in the immediate proximity of the corresponding outer edge 19.

This means that they are at a distance of less than 7 cm, preferably 5 cm, more preferably 3 cm.

As shown in FIG. 1, each bipolar plate 9 includes an inlet for anodic fluid, an inlet 27 for cathodic fluid, an outlet for cathodic fluid 29, an outlet for anodic fluid 30, and an inlet for cathodic fluid 33.

Each bipolar plate 9 also includes an outlet 35 for coolant and an inlet 37 for coolant.

Likewise, each MEA 3 includes an inlet 39 for anodic fluid, an outlet 41 for cathodic fluid, an inlet 43 for anodic fluid, and an outlet 45 for cathodic fluid,

Each MEA 3 also includes an inlet 47 for coolant and an outlet 49 for coolant.

The openings 39-49 are arranged in the outer circumferential frame 10, and are made of plastic.

The openings of the bipolar plates and MEAs are superimposed, thus forming an anodic fluid intake manifold, a cathodic fluid intake manifold, an anodic fluid drainage manifold, and a cathodic fluid drainage manifold.

The superimposed openings also form a coolant intake manifold and a coolant drainage manifold.

The anodic fluid circulates through the anodic volume 11 from the opening 27 to the opening 31. The cathodic fluid circulates through the cathodic volume 13 from the opening 33 to the opening 29.

The coolant circulates within the bipolar plate 9 from the opening 37 to the opening 35.

The cordon 15 of sealing material and/or the direct contact line 17 extends around one or more of the openings, preferably around each of the openings.

More precisely, the cordon 15 of sealing material and/or the direct contact line 17 comprise portions 50 that each extend around one of the openings. These portions 50 have closed contours or are connected to the portions 23, 25 that follow the outer circumferential edge 21 of the MEA 3.

Each portion 50 of the direct contact line 17 is in direct contact with the outer circumferential frame 10, and creates a seal for the fluid circulating through the corresponding opening.

As shown in FIG. 2, each bipolar plate 9 includes a rib 51 protruding towards the adjacent MEA 3. The cordon 15 of sealing material 15 and/or the direct contact line 17 follows the rib 51.

More specifically, the cordon 15 is interposed between a flat strip 53 that forms the peak of the rib 51 and the MEA 3.

Likewise, the direct contact line 17 places a flat strip 53 forming the peak of the rib 51 in direct contact with the MEA 3.

As described supra, each bipolar plate 9 typically consists of two metal sheets assembled together. Only one of the two metal sheets is shown in FIG. 2. The bipolar plate 9 is placed between two MEAs 3, with a first sheet facing a first MEA 3 and the second sheet facing the second MEA 3.

The first metal sheet includes a rib 51 protruding towards the first MEA 3. The rib is obtained by deforming the metal sheet, and it is hollow in the direction of the second metal sheet.

The second metal sheet includes a rib 51 protruding towards the second MEA 3. The rib is obtained by deforming the metal sheet, and it is hollow in the direction of the first metal sheet.

In one variant, the cordon 15 and/or the direct contact line 17 are formed in flat zones of the bipolar plate 9 with no ribs.

In one embodiment shown in FIG. 3, the MEA 3 is in direct contact along the direct contact line 17 with a textured zone 55 of the bipolar plate 9.

This allows for a better seal for the fluid circulating between the MEA 3 and the bipolar plate 9.

Indeed, the textured zone 55 includes embossments 57 protruding towards the MEA 3 and pressing into the MEA 3.

The embossments 57 are of any suitable type. For example, they are narrow ribs extending along the contact line 17. In other words, each narrow rib has the same outline as the contact line 17 and follows it.

For example, the textured zone 55 includes two narrow ribs, parallel to one another, or a surface texture that improves the seal.

Advantageously, the textured area 55 is arranged on the flat strip 53 that forms the peak of the rib 51.

The intervention also concerns a method for producing a fuel cell.

The fuel cell 1 described supra is particularly well suited to be produced by the method according to the invention. Conversely, the method according to the invention is particularly well suited to produce the fuel cell 1 described supra.

The method comprises the following steps:
obtaining a plurality of membrane-electrode assemblies (MEAs) 3, each comprising an active zone 4 having an anode 5 and a cathode 7;
obtaining a plurality of bipolar plates 9;
stacking the MEAs 3 and the bipolar plates 9 such that each MEA 3 is arranged between two bipolar plates 9, wherein an anodic volume 11 for the circulation of an anodic fluid is delimited between the anode 5 and one of the two bipolar plates 9, a cathodic volume 13 for the circulation of an cathodic fluid is delimited between the anode 7 and the other of the two bipolar plates 9.

The MEAs 3 are as described above.

The bipolar plates 9 are as described above.

The fuel cell typically comprises tens to hundreds of MEAs and tens to hundreds of bipolar plates 9.

The method further comprises the following steps:
for each MEA 3: depositing a cordon 15 of a sealing material on one of the anodic volume 11 and the cathodic volume 13 between the MEA 3 and the corresponding bipolar plate 9;
compressing the stack, wherein the one of the anodic volume 11 and the cathodic volume 13 is enclosed by the sealing material, which comes into direct contact with the MEA 3 and the corresponding bipolar plate 9;

wherein the other of the anodic volume 11 and the cathodic volume 13 is sealed off from the fluid circulating in the volume by the MEA 3 being placed in direct with the corresponding bipolar plate 9 along a direct contact line 17.

The sealing material is as described supra.

For example, the deposition step is carried out before the stacking step.

The cordon 15 is deposited both on the MEA 3 and the bipolar plate 9.

The cordon 15 is deposited by any suitable means. For example, the cordon is obtained by injection moulding, then deposited on the MEA 3 or the bipolar plate 9. In one variant, the MEA 3 or the bipolar plate 9 is placed in an injection mould, and the sealing material is injected or overmoulded in a cavity of the mould in the shame of the cordon 15. In another variant, the sealing material is directly extruded onto the MEA 3 or the bipolar plate 9 along the outline of the cordon 15.

The outline of the cordon 15 is as described above.

The compression is carried out in a compression direction corresponding to the stacking direction E shown in FIG. 1. This direction is substantially perpendicular to the MEA 3s and bipolar plates 9.

The compression force is typically between 10 and 30 KN, preferably between 20 and 25 KN.

The direct contact line 17 is as described supra. Its outline is as described above.

Following the compression step, the bipolar plates 9 and the MEAs 3 are kept compressed at substantially the same pressure by placement of fixation devices such as anchors (not shown). The seal at the level of the anodic volume 11 and cathodic volume 13 is thus maintained.

It should be noted that, in the fuel cell described supra, the cordon 15 and the direct contact line 17 are the outermost joints on the MEAs 3 and plates 9. They create the seal for the anodic and cathodic volumes 11, 13 relative to the outside of the fuel cell.

Preferably, the fuel cell does not include any seals other than the cordon 15 and the direct contact line 17 between the MEA 3 and the plates 9.

1. A fuel cell, comprising:
a plurality of membrane-electrode assemblies (MEAs), each comprising an active zone having an anode and a cathode;
a plurality of bipolar plates;
wherein the MEAs and the bipolar plates are stacked such that each MEA is arranged between two bipolar plates, wherein an anodic volume for the circulation of an anodic fluid is delimited between the anode and one of the two bipolar plates, wherein a cathodic volume for the circulation of an cathodic fluid is delimited between the anode and the other of the two bipolar plates,
wherein one of the anodic volume and the cathodic volume is sealed by a cordon of a sealing material, wherein the sealing material is in direct contact with the MEA and the corresponding bipolar plate;
wherein the other of the anodic volume and the cathodic volume is sealed off from the fluid circulating in the volume by a direct contact line of the MEA with the corresponding bipolar plate.

2. The fuel cell according to claim 1, wherein the sealing material is a silicone, an EPDM, or a thermoplastic.

3. The fuel cell according to claim 1, wherein the cordon of sealing material has a thickness of between 0.25 and 0.75 mm.

4. The fuel cell according to claim 1, wherein the MEA has an outer circumferential frame of a plastic material surrounding the active zone, wherein the corresponding bipolar plate is in direct contact with the outer circumferential frame.

5. The fuel cell according to claim 1, wherein the MEA is in direct contact with a metal zone of the bipolar plate.

6. The fuel cell according to claim 1, wherein the MEA is in direct contact with a textured zone of the bipolar plate.

7. The fuel cell according to claim 1, wherein each bipolar plate has an outer plate edge, wherein the portion of the cordon of sealing material follows the outer plate edge.

8. The fuel cell according to claim 1, wherein each bipolar plate has an outer plate edge, wherein the portion of the contact line follows the outer plate edge.

9. The fuel cell according to claim 1, wherein each bipolar plate includes an inlet for anodic fluid, an inlet for cathodic fluid, an outlet for anodic fluid, and an outlet for cathodic fluid, wherein the cordon of sealing material and/or the direct contact line extend around one or more of the openings.

10. A method for producing a fuel cell, wherein the method comprises the following steps:
obtaining a plurality of membrane-electrode assemblies (MEAs), each comprising an active zone having an anode and a cathode;
obtaining a plurality of bipolar plates;
stacking the MEAs and the bipolar plates such that each MEA is arranged between two bipolar plates, wherein an anodic volume for the circulation of an anodic fluid is delimited between the anode and one of the two bipolar plates, wherein a cathodic volume for the circulation of an cathodic fluid is delimited between the anode and the other of the two bipolar plates,
for each MEA: depositing a cordon of a sealing material on one of the anodic volume and the cathodic volume between the MEA and the corresponding bipolar plate;
compressing the stack, wherein the one of the anodic volume and the cathodic volume is sealed by the sealing material, which comes into direct contact with the MEA and the corresponding bipolar plate;
wherein the other of the anodic volume and the cathodic volume is sealed off from the fluid circulating in the volume by the MEA being placed in direct with the corresponding bipolar plate along a direct contact line.
